(19) United States
(12) Patent Application Publication
(10) Pub. No.: US 2010/0239363 A1
(43) Pub. Date: Sep. 23, 2010

(54) CONNECTING FLANGE FOR TRANSMISSION ELEMENTS OF CYCLES AND MOTORCYCLES

(75) Inventor: Alessandro Cerasi, Monte San Pietro (IT)

Correspondence Address: DENNISON, SCHULTZ & MACDONALD, 1727 KING STREET, SUITE 105, ALEXANDRIA, VA, 22314, US

(73) Assignee: MPT PLASTICA S.R.L., Calcinaia (IT)

(21) Appl. No.: 12/682,827

(22) PCT Filed: Oct. 28, 2008
(86) PCT No.: PCT/EP2008/064599

§ 371 Date: May 20, 2010

(30) Foreign Application Priority Data
Oct. 30, 2007 (IT) BO2007A000725

(51) Int. Cl. F16D 1/06

(52) U.S. Cl. 403/202

(57) ABSTRACT

A connecting flange (1) for transmission elements of cycles and motorcycles, comprising a disk (2) provided with a central hole (3) whose shape and dimensions are complementary to those of the hub (4) of a wheel (5) and provided with elements (6) for coupling to the hub (4), the perimetric rim (7) of the disk (2) comprising anchoring means (8) for at least one ring gear (9).

### TECHNICAL FIELD

The present invention relates to a connecting flange for transmission elements of cycles and motorcycles.

### BACKGROUND ART

Transmission in cycles and motorcycles is generally provided by means of belts and chains, except for rare cases in which cardan joints are used.

In practice, the chain (or belt) engages a gear that protrudes from the gearbox (or the gear that is jointly connected to the pedals, in the case of bicycles) at one end and on a ring gear that is jointly connected to the hub of the rear wheel at the other end.

Such ring gear, according to requirements, may be provided according to types that have a different number of teeth in order to define respective gear ratios.

In the specific sector of motorcycles, although all wheels have common characteristics and although their hubs have an anchoring surface for ring gears of a type that is substantially universal (or in any case standardized according to a minimum number of possible combinations), it is straightforward to verify that each motorcycle has its own specific ring gear, which is unsuitable to be mounted on other models.

In practice, this complicates customizations and modifications of motorcycles (especially those used for racing), since it is necessary to adopt components of a type that is completely compatible with the original.

In addition to the complexity of assembly and disassembly, it is necessary to consider the need, for operators in the field, to have available the entire range of ring gears in use for each commercially available model/make, in order to be able to meet the requirements of any customer.

Of course, having a large inventory of goods is a severe drawback from an economic standpoint.

Moreover, these components will be subjected to extremely intense mechanical stresses and therefore must be made of high-strength materials.

This means that a traditional steel ring gear is unquestionably an extremely valid and durable component, but its weight will constitute a severe handicap in the case of competitive use.

On the other hand, replacing the steel ring gear with a lightweight one, made for example of aluminum, in order to reduce overall weight to the benefit of the performance of the motorcycle, is a risky choice: the mechanical strength of the component might be insufficient to ensure an acceptable average life thereof.

### DISCLOSURE OF THE INVENTION

The aim of the present invention is to provide a connecting flange for transmission elements of cycles and motorcycles that is suitable for installation on cycles and motorcycles of any make and model.

Within this aim, an object of the present invention is to provide a connecting flange for transmission elements of cycles and motorcycles that is lightweight and has high mechanical strength.

Another object of the present invention is to provide a connecting flange for transmission elements of cycles and motorcycles whose shape and dimensions are standardized and universal.

Another object of the present invention is to provide a connecting flange for transmission elements of cycles and motorcycles that has low costs, is relatively simple to provide in practice, and is safe in application.

This aim and these and other objects which will become better apparent hereinafter are achieved by the present connecting flange for transmission elements of cycles and motorcycles, characterized in that it comprises a disk provided with a central hole whose shape and dimensions are complementary to those of a hub of a wheel and provided with elements for coupling to said hub, the perimetric rim of said disk comprising anchoring means for at least one ring gear.

### BRIEF DESCRIPTION OF THE DRAWINGS

Further characteristics and advantages of the invention will become better apparent from the following detailed description of a preferred but not exclusive embodiment of a connecting flange for transmission elements of cycles and motorcycles, illustrated by way of non-limiting example in the accompanying drawings, wherein:

FIG. 1 is a bottom perspective view of a flange according to the invention;

FIG. 2 is a bottom perspective view of a flange according to the invention;

FIG. 3 is a side view of a flange according to the invention;

FIG. 4 is a bottom perspective view of a flange according to the invention associated with a respective hub of a wheel;

FIG. 5 is a top view of a ring gear suitable for association with a flange according to the invention;

FIG. 6 is an exploded top view of a ring gear suitable for association with a flange according to the invention;

FIG. 7 is a side view of a wheel provided with a flange and a ring gear according to the invention.

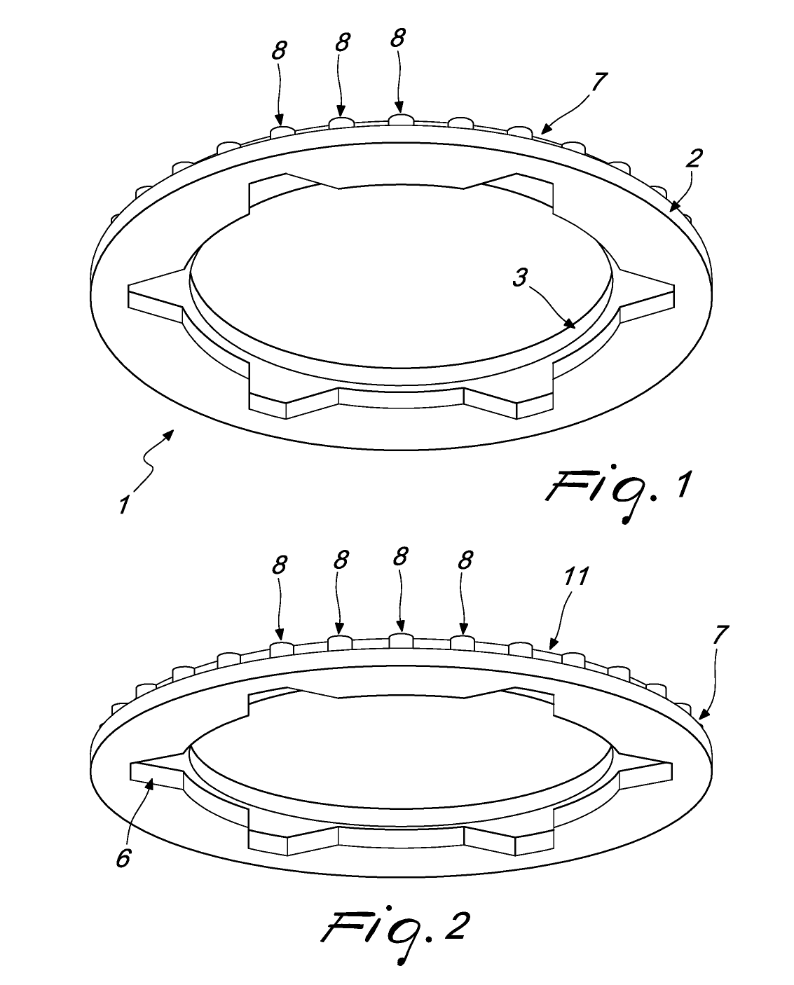

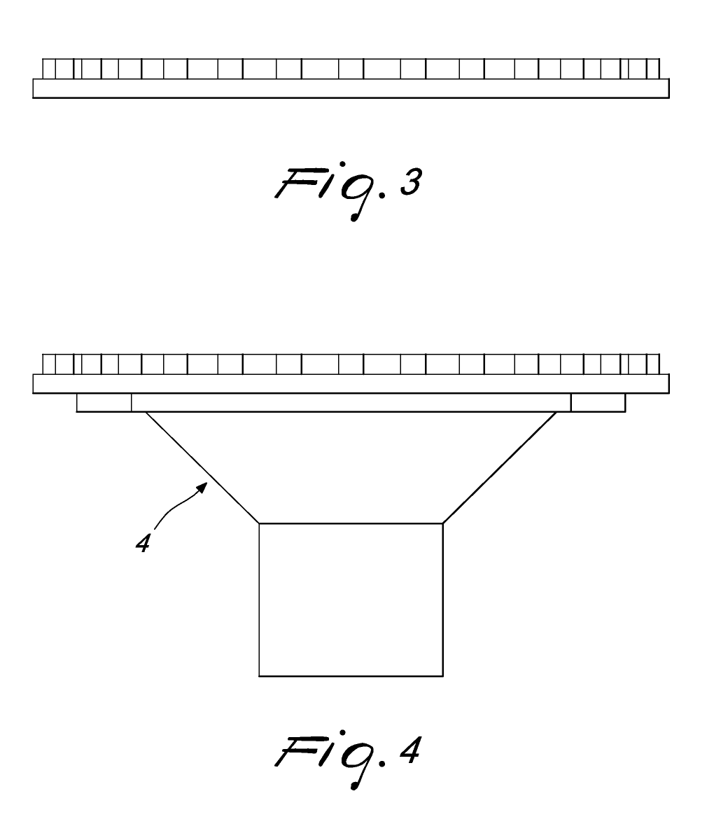

### WAYS OF CARRYING OUT THE INVENTION

With reference to the figures, the reference numeral 1 designates a connecting flange for transmission elements of cycles and motorcycles.

The flange 1 comprises a disk 2, which is provided with a central hole 3 whose shape and dimensions are complementary to those of a hub 4 of a wheel 5 and is provided with elements 6 for coupling to the hub 4.

In practice, in cycles and motorcycles of the known type, the driving element (for example the pinion that protrudes from the gearbox of some motorcycles or the front gear that is jointly connected to the pedals, typical of bicycles) is coupled to the driving wheel (generally the rear wheel) by means of a chain or a belt, which engages a rear ring gear jointly connected to the hub of the wheel.

In this case, the component that is jointly connected to the hub of the wheel is the disk 2 that constitutes the flange 1.

A perimetric edge 7 of the disk 2 comprises anchoring means 8 for at least one ring gear 9: the ring gear 9, both from a dimensional standpoint and from a structural standpoint, has characteristics that are completely different from those of a ring gear of the traditional type. First of all, the extremely small dimensions ensure that the weight associated with the transmission elements is minimized even if one decides to provide the ring gear 8 made of heavy material (for example steel) in order to obtain the best mechanical performance.

According to a particular embodiment of unquestionable practical interest, the disk 2 is made of composite material with high mechanical strength and low specific gravity: for example, it is possible to make the disk 2 of glass-filled polyamide (trade name Nylon). This material has excellent characteristics of mechanical strength and good elasticity, in particular the combination of Nylon 66 and glass fibers provides an optimum combination for the specific embodiment.

According to a solution that is alternative to the one described above, the disk 2 can be made of polymeric material with high mechanical strength and low specific gravity.

According to a further embodiment, the disk 2 can be made of metallic material with high mechanical strength and low specific gravity: in this case, it is useful to adopt aluminum (particularly high-performance aluminum alloys of aeronautical and military origin) and/or titanium.

In any case, the possibility is not ruled out of making the disk 2 of ceramic material or by means of components obtained by sintering ceramic materials and metallic and/or polymeric materials in order to obtain optimum mechanical rigidity even with extremely low specific gravities.

The elements 6 for coupling to the hub 4 of the disk 2 are threaded elements, which are clamped on the disk 2 and the hub 4 with respective threaded fastening units: in particular, it is possible to adopt screws (whose number depends on the number of holes provided in the hub 4) with the respective locking nuts (taking care to privilege components that are suitable for work in the presence of intense vibrations, in order to avoid unwanted opening during use).

In order to be able to mate with all the hubs 4, the disk 2 comprises a plurality of perimetric holes at its inner central hole 3, which are distributed angularly so as to match any distribution adopted by the manufacturers of wheels 5 and hubs 4: the disk 2 of the flange 1 according to the invention can thus be mounted on any huh 4 of wheels 5 of the commercial type that correspond to the means of transport for which it has been designed.

In practice, it is sufficient to provide at least one disk 4 for racing cycles and touring cycles, at least one for mountain bikes, and at least one specific disk 4 for road motorcycles, touring motorcycles, enduro motorcycles, trial motorcycles, supermotard motorcycles and motocross motorcycles, in order to be able to work on any existing two-wheeled vehicle.

The ring gear 9 is substantially annular and has a minimal width: it is provided internally with the means 8 for anchoring to the outer perimetric edge 7 of the disk 2, and is provided on the outside with a series of teeth for mating with the chain (or toothed belt) designed for movement.

The ring gear 9 is constituted by at least two curved portions 9a and 9b, which are mounted in succession so that their end edges 10 face each other and are in mutual contact so as to define a continuity of the ring gear 9.

This embodiment allows to produce ring gears 9 at costs that are reduced significantly with respect to known types of ring gear: starting from a metallic lamina (made of steel) it is in fact possible to crop the curved portions 9a and 9b, minimizing waste: small arcs can in fact be arranged so as to partially overlap their contours, in order to use most of the available material.

Equally positively, the ring gear 9 constituted by contiguous curved portions can be disassembled without having to remove the wheel from the frame (of a bicycle or motorcycle), greatly simplifying maintenance and replacement operations as well as operations for changing the characteristics of the motorcycle (or bicycle) according to the requirements of use (by changing the total number of teeth it is possible to change the transmission ratio).

The ring gear 9 can be provided with any number of teeth comprised between 43 and 54: this allows to modify any motorcycle (or bicycle) by giving it the desired gear ratio even if the manufacturer has not provided for specific conversion kits for the vehicle to be modified.

According to a possible embodiment of assured interest in practice and in application, the anchoring means 8 comprise a succession of interfering protrusions 11 of the disk 2 that are suitable for stable engagement within appropriately provided complementarily shaped slots 12 provided on an inner edge 13 of the ring gear 9.

In this manner it is possible to provide an interference coupling between the disk 2 and the ring gear 9: this coupling ensures the best possible transfer of motion between the transmission chain (or belt) and the hub of the wheel.

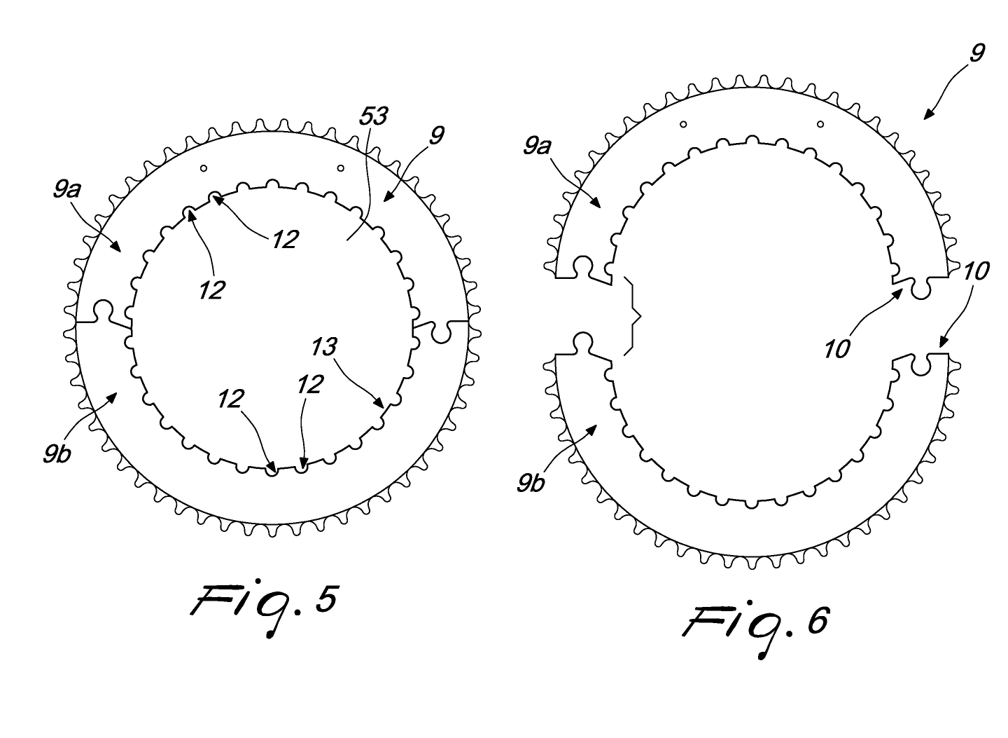

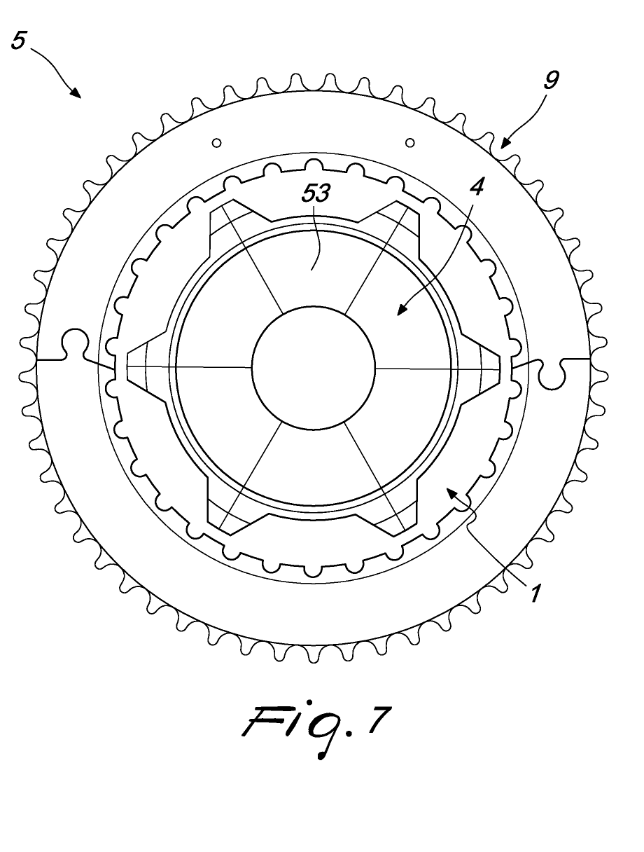

According to the embodiment shown in FIGS. 5 and 6, the protrusions 11 and the slots 12 are semicircular: any other shape, so long as it is mutually complementary, may be used in any case without abandoning the scope of the present application.

It has thus been shown that the invention achieves the proposed aim and objects.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and dimensions, may be any according to requirements without thereby abandoning the scope of the protection of the appended claims.

The disclosures in Italian Patent Application No. B02007A000725 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A connecting flange (1) for transmission elements of cycles and motorcycles, characterized in that it comprises a disk (2) provided with a central hole (3) whose shape and dimensions are complementary to those of a hub (4) of a wheel (5) and provided with elements (6) for coupling to said hub (4), the perimetric rim (7) of said disk (4) comprising anchoring means (8) for at least one ring gear (9).

2. The flange according to claim 1, characterized in that said disk (4) is made of a composite material with high mechanical strength and low specific gravity.

3. The flange according to claim 1, characterized in that said disk (4) is made of polymeric material with high mechanical strength and low specific gravity.

4. The flange according to claim 1, characterized in that said disk (4) is made of metallic material with high mechanical strength and low specific gravity.

5. The flange according to claim 1, characterized in that said elements (6) for coupling to said hub (4) are threaded elements which are clamped on the disk (2) and the hub (4) with respective threaded clamping units.

6. The flange according to claim 1, characterized in that said ring gear (9) is substantially annular and has a minimal width.

7. The flange according to claim 6, characterized in that said ring gear (9) is constituted by at least two curved portions (9a, 9b), which are mounted in succession so that their end edges (10) face each other and are in mutual contact so as to define a continuity of said ring gear (9).

8. The flange according to claim 1, characterized in that said ring gear (9) has a number of teeth comprised between 43 and 54.

9. The flange according to claim 1, characterized in that said anchoring means (8) comprise a succession of interfering protrusions (11) of the disk (2), which are suitable for stable engagement within appropriately provided complementarily shaped slots (12) provided on the inner edge (13) of the ring gear (9).

10. The flange according to claim 9, characterized in that said protrusions (11) and said slots (12) have a semicircular shape.
